(19) United States
(12) Patent Application Publication
(10) Pub. No.: US 2019/0128338 A1
(43) Pub. Date: May 2, 2019

(54) ROTARY FEEDTHROUGH FOR A FLUID AND CLUTCH ARRANGEMENT COMPRISING SUCH A ROTARY FEEDTHROUGH

(71) Applicant: BorgWarner Inc., Auburn Hills, MI (US)

(72) Inventors: Klaus WOLK, Bidingen (DE); Friedrich Philipp BREZGER, Karlsruhe (DE)

(21) Appl. No.: 16/169,530

(22) Filed: Oct. 24, 2018

(30) Foreign Application Priority Data
Oct. 26, 2017 (DE) 102017009955.3

(51) Int. Cl. F16D 25/08; F16D 21/06; F16D 25/0638; F16D 25/12

(52) U.S. Cl. CPC F16D 25/083; F16D 21/06; F16D 2127/06; F16D 25/12; F16D 2021/0607; F16D 25/0638

(57) ABSTRACT

The present invention relates to a rotary feedthrough (6) for a fluid comprising a first component (44) with a first supply line (50) and a second component (42) with a second supply line (56), which are arranged radially nested to form an intermediate annular space (52) and are rotatable relative to one another, wherein the first supply line (50) and the second supply line (56) are fluidly connected or fluidly connectable via a connection space (54) formed in the annular space (52). At least one closure part (62) is arranged in the annular space (52) and is translatable from an open position, in which the first and second supply line (50, 56) are fluidly connected via the connection space (54), into a closed position, in which the first and second supply line (50, 56) are fluidly decoupled. The present invention further relates to a clutch arrangement (2) comprising such a rotary feedthrough (6).

### CROSS-REFERENCE TO RELATED APPLICATIONS

This application claims the benefit of German Patent Application No. 102017009955.3 filed Oct. 26, 2017, the disclosure of which is herein incorporated by reference in its entirety.

### DESCRIPTION

The present invention relates to a rotary feedthrough for a fluid comprising a first component with a first supply line and a second component with a second supply line, which are arranged radially nested while forming an intermediate annular space and are rotatable relative to one another, wherein the first supply line and the second supply line are fluidly connected or fluidly connectable via a connection space formed in the annular space. In addition, the present invention relates to a clutch arrangement comprising a hydraulically actuatable clutch device and such a rotary feedthrough.

Clutch arrangements with a hydraulically actuated clutch device are known from the prior art. The clutch device thereby has at least one clutch, to which a pressure chamber interacting with an actuating piston is assigned for actuating the clutch. Thus, the clutch may be closed, for example, by an increase of hydraulic pressure within the pressure chamber, wherein the corresponding closing force is translated to the clutch, for example, a disk clutch, via the actuating piston. To be able to transfer the hydraulic fluid into the pressure chamber or to direct it out of the same, the clutch device has a clutch hub in which a supply line opening into the pressure chamber is designed. The clutch hub is arranged radially nested with a support tube in such a way that an annular space is formed between the clutch hub and the support tube, wherein the clutch hub is rotatable relative to the support tube. An additional supply line is provided in turn in the support tube itself, wherein the two supply lines are fluidly connected via a connecting space formed in the annular space. Consequently, the clutch hub with the supply line and the support tube with the additional supply line, together with the connection space within the annular space, form a rotary feedthrough via which the hydraulic fluid may arrive in the pressure chamber of the clutch and may be directed out of the same.

In order to be able to continuously hold the previously described clutch arrangement closed, without having to continuously maintain the supply pressure at a high level, these clutches are sometimes designed as lockable clutches. Thus, solutions are known in which the actuating piston may be locked mechanically or in a positive-locking way in its actuating position, so that the pressure may be at least reduced within the assigned pressure chamber. In addition, solutions were developed, in which the pressure built up in the supply lines and the pressure chamber is preserved or maintained, in that a valve is connected upstream of the supply lines and the pressure chamber and is closed for this purpose. Such a valve may be provided, for example, within the supply line in the support tube. However, it has been demonstrated in the latter solution that the relatively high pressure also acts within the rotary feedthrough, which may consequently lead to leakage losses. Another solution, in which a corresponding valve is arranged in the supply line of the clutch hub, might indeed relieve the rotary feedthrough and thus reduce potential leakage losses; however, it has been demonstrated that a valve of this type may only be controlled with difficulty and with increased design expense due to its positioning within the supply line of the clutch hub. In addition, the necessary installation space for its incorporation is often lacking.

It is therefore the object of the present invention to create a rotary feedthrough, in particularly a rotary feedthrough for a clutch arrangement of the generic type, and a clutch arrangement with such a rotary feedthrough, which has a simple and compact structure while overcoming the previously listed problems.

This problem is solved by the features listed in Patent claim 1 or 11. Advantageous embodiments of the invention are the subject matter of the subclaims.

The rotary feedthrough according to the invention functions to feed through a fluid, preferably a hydraulic fluid, particularly preferably to feed through a hydraulic fluid for a hydraulically-actuated clutch device. The rotary feedthrough has a first component with a first supply line and a second component with a second supply line. The two supply lines may thereby be designed as fluid lines arranged within the respective component. The two components, which are preferably designed as cylindrical or tubular on the one side, and tubular on the other side, are arranged nested in the radial direction to form an intermediate annular space and are rotatable relative to one another, preferably about an axis of rotation extending in the axial direction, said axis of rotation is particularly preferably designed as a coaxial axis of rotation for the two components. Basically, the two components may be designed as rotatable; however, it is generally preferred if one of the components is designed as stationary and the other component is designed as rotatable. A connection space, which is formed within the annular space between the two components, is analogously formed by a section of the annular space, wherein the first supply line of the first component and the second supply line of the second component are fluidly connected or fluidly connectable via the connection space. Thus, for example, the two ends of the supply lines may open out into the connection space within the annular space in order to achieve the specified fluid connection between the first and second supply line via the connection space. Furthermore, at least one closure part is arranged in the annular space, wherein the closure part is preferably designed as a ring or annular. The closure part may be transitioned, preferably displaced, within the annular space from an open position, in which the first and second supply line are fluidly connected via the connection space, into a closed position, in which the first and second supply line are fluidly decoupled, and vice versa. Thus, for example, a fluid pressure in the first or second supply line, which had been built up via the second or first supply line via the connection space, may be maintained or preserved, in that the closure part is translated into the closed position, wherein, in connection with this, the original pressure within the second or first supply line may be reduced to save energy. Due to the arrangement of the closure part within the annular space, for example, in contrast to a valve within one of the supply lines, a particularly simple, compact, and easily manufactured structure is created, which in addition facilitates a relatively easy and direct control of the closure part. Thus, a rotary feedthrough of the type according to the invention is particularly suited for a clutch arrangement of the type described later in greater detail.

In one advantageous embodiment of the rotary feedthrough according to the invention, the closure part is designed as annular or as a ring or as an annular piston.

According to another advantageous embodiment of the rotary feedthrough according to the invention, the closure part is displaceable from the open position into the closed position and vice versa, wherein this is consequently a translational movement. It is hereby preferred if the closure part is displaceable in the axial direction of the rotary feedthrough in order to arrive at the open position or the closed position.

In one preferred embodiment of the rotary feedthrough seal according to the invention, the closure part is in rotary driving connection with one of the two components, preferably with the second component of the rotary feedthrough. This has the advantage that no relative rotation takes place at least between one of the two components, preferably the second component, and the closure part, by which means a particularly simple and reliable sealing is possible of the area between the closure part and this component.

In one particularly advantageous embodiment of the rotary feedthrough according to the invention, the closure part may be hydraulically driven in order to achieve a particularly compact design and a simple control. It is hereby preferred if a pressure chamber, likewise formed in the annular space, is assigned to the closure part, and a control pressure may be applied to said pressure chamber for driving the closure part. The closure part, in particular its active surface facing the pressure chamber, is also preferably designed in such a way that a control pressure, which is already sufficient to translate the closure part from its open position into its closed position, is lower than a fluid pressure within the first and/or second supply line and/or in the connection space. It is particularly preferred in this embodiment if the control pressure may be changed independently of the fluid pressure within the first supply line and/or independently of the fluid pressure within the second supply line, where appropriate also independently of the fluid pressure within the connection space.

In another advantageous embodiment of the rotary feedthrough according to the invention, a control line for applying the control pressure to the pressure chamber is provided in the first or second component, preferably in that component which is designed as non-rotating or stationary. As already previously indicated, the control line is designed preferably separately from the first and second supply line, and pressure may be applied to it in order to be able to change the control pressure within the pressure chamber independently of the fluid pressure in the supply lines and also the connection space.

In another advantageous embodiment of the rotary feedthrough according to the invention, the previously mentioned pressure chamber is designed on the side of the closure part facing away from the connection space in the axial direction. It is hereby preferred if the closure part directly delimits both by the pressure chamber and also the connection space.

In one preferred embodiment of the rotary feedthrough according to the invention, the closure part has a first active surface, which is exposed to a fluid pressure in the first supply line in the closed position of the closure part and is designed in such a way that the fluid pressure in the first supply line results in a force acting on the adjusting part in the direction of the open position. The specified active surface does not itself have to be arranged within the first supply line, rather said active surface is preferably assigned to the connection space in which the specified fluid pressure is generated via the first supply line. In any case, a movement of the adjusting part from its closed position into its open position may be caused by a simple increase in the fluid pressure in the first supply line if the pressure within the pressure chamber assigned to the closure part is correspondingly low, so that basically no reset means, for example, a spring, has to be provided to translate the closure part from its closed position back into the open position.

In another preferred embodiment of the rotary feedthrough according to the invention, the closure part has a second active surface which is exposed to a fluid pressure in the second supply line in the closed position of the closure part and is designed in such a way that the fluid pressure in the second supply line results in a force acting on the adjusting part in the direction of the open position. It is also preferred in this embodiment if the second active surface is assigned to a section of the connection space in which the specified fluid pressure is generated via the second supply line in order to act on this second active surface. A so-called fail-safe function is ensured by this embodiment. If, for example, a fluid pressure within the second supply line should have been maintained or preserved by translating the closure part into its closed position, while the pressure had been reduced in the first supply line, then a drop or loss of the fluid supply would initially lead to a reduction of the control pressure within the pressure chamber, while the fluid pressure remained maintained in the second supply line. If the control pressure drops too far in such a way that the force acting on the closure part via the second active surface due to the fluid pressure in the second supply line is greater than the drive force, then the adjusting part is automatically displaced from the closed position back into the open position due to this force, so that the pressure within the second supply line may be relieved again via the connection space and the first supply line.

In another advantageous embodiment of the rotary feedthrough according to the invention, the first active surface and/or the second active surface of the closure part is smaller than an active surface of the closure part facing the pressure chamber to ensure a translation of the closure part into the closed position via a low control pressure within the pressure chamber if the fluid pressure in the first and/or second supply line is greater than the control pressure in the pressure chamber.

In one particularly preferred embodiment of the rotary feedthrough according to the invention, a seal for sealing the connection space is provided between the closure part and the first component, is preferably arranged on the closure part, and may be moved together with the closure part when the closure part is displaced from the open position into the closed position and vice versa. For this purpose, the seal is arranged preferably in a groove in the closure part, wherein the seal is formed, where appropriate, as a ring seal or a torlon ring. By arranging the seal on the closure part, a particularly compact design may be achieved, particularly as such a seal—like a classic seal within a rotary feedthrough—may function for sealing the connection space; yet, in addition may also function for separating the connection space and pressure chamber within the annular space, as this is additionally preferred.

According to another preferred embodiment of the rotary feedthrough according to the invention, a seal, acting between the closure part and the second component, is provided for sealing the connection space, wherein this seal is preferably arranged on the second component. Thus, this seal may be designed, for example, as a ring seal. In order to arrange the seal on the second component, particularly in order to fix it on the same, it is thereby preferred if this is arranged in a groove in the second component.

In another preferred embodiment of the rotary feedthrough according to the invention, the previously mentioned seal, acting between the closure part and the second component to seal the connection space while achieving a rotary driving connection between the closure part and the second component, is fixed on the one side on the closure part and on the other side on the second component. It has hereby proven advantageous if the specified seal is formed as a flexible flat seal, which on the one hand facilitates a movement of the closure part between the open and closed positions, yet on the other hand effects the sealing of the connection space between the closure part and the second component.

In another preferred embodiment of the rotary feedthrough according to the invention, the closure part is supported or supportable in its closed position on the second component in the axial direction in order to guarantee an exact positioning of the same in the closed position. A radial support section is thereby preferably provided on the second component, which projects in the radial direction and, where appropriate, is designed as extending in the circumferential direction. Thus, the radial support projection may, for example, be substantially designed as a support ring. In this embodiment, it is preferred if the radial support projection is designed as an attached part on the second component so that the radial support projection may be initially manufactured as a separate component. Within the context of the assembly, an annular closure part may initially be pushed onto the second component, or inserted into the same, before the attached part is applied. It is preferred in the assembled state, if the attached part is eventually fixed rotationally fixed and/or in the axial direction on the second component. Alternatively to the design of the radial support projection as an attached part, the support projection may, however, also be designed as one piece with the second component.

According to one particularly advantageous embodiment of the rotary feedthrough according to the invention, a seal, acting between the closure part and the second component, where appropriate the support projection, is provided for sealing the first supply line with respect to the second supply line in the closed position of the closure part in order to achieve a particularly secure fluid decoupling of the first and second supply lines in the closed position of the closure part. Basically, the specified seal may be arranged on the closure part or on the second component or on its support projection. However, it has proven advantageous if the seal is arranged on the second component, where appropriate on the support projection. Thus, the seal may be arranged in a captive way, for example, within a groove of the support projection.

Basically, the closure part might be supported or supportable in its closed position on the second component or the support projection in the axial direction with strong compression of the seal, so that there is absolutely no contact between the closure part and the second component or the support projection in the axial direction, and the closure part would consequently be only indirectly supported or supportable on the second component or the support projection via the seal. However, this would lead to an increased wear or an increased load on the seal, so that in another preferred embodiment of the rotary feedthrough seal according to the invention, the closure part is supported or supportable in its closed position in the axial direction both directly on the second component and/or the support projection and also indirectly via the seal under a partial compression of the seal, in order to reduce the load on the seal and to guarantee an exact positioning of the closure part in its closed position.

In order to be able to move the closure part in a non-tiltable way and precisely between the closed position and the open position, in another preferred embodiment of the rotary feedthrough according to the invention, the closure part is supported or supportable both in the closed position and also in the open position on the second component in the radial direction in two support areas, separated from one another in the axial direction. In other words, an intermediate area is provided, in particular, between the two support areas, in which the closure part is not supported or supportable on the second component in the radial direction; consequently, it may also be stated that the closure part is supported or supportable in the radial direction on the second component in a way which bridges an intermediate area. It is preferred in this embodiment if the closure part is supported or supportable in one of the two support areas via multiple projections spaced apart from one another with intermediate spaces lying therebetween on the second component, where appropriate on the support projection in the radial direction, in such away that the first and second supply line are fluidly connected via the intermediate spaces in the open position of the closure part. It is also preferred in this embodiment variant if the projections are spaced apart from one another in the circumferential direction, wherein the projections may be preferably uniformly spaced apart from one another and/or have the same extension in the circumferential direction.

In another advantageous embodiment of the rotary feedthrough according to the invention, one of the components is designed as stationary or non-rotating, wherein preferably the first component is designed as stationary or non-rotating.

In another preferred embodiment of the rotary feedthrough according to the invention, the second component is designed as the radially inner component, while the first component is the radially outer component.

To create a rotary feedthrough which provides more than one supply path for the fluid and is thus also particularly suited for a double clutch device, a third supply line is provided in the first component and a fourth supply line is provided in the second component, which are fluidly connected or fluidly connectable via a second connection space formed in the annular space in another preferred embodiment of the rotary feedthrough according to the invention. In addition, a second closure part is thereby arranged in the annular space, which is translatable from an open position, in which the third and fourth supply lines are fluidly connected via the connection space, into a closed position, in which the third and fourth supply line are fluidly decoupled. In this embodiment, the embodiment variants previously described with reference to the first supply line, the second supply line, and the first specified closure part, are also preferred.

In another particularly advantageous embodiment of the rotary feedthrough according to the invention, the closure part and the second closure part are translatable from the open position into the closed position in opposite directions from one another, in order to create, for example, two closely adjacent pressure chambers for the two closure parts which may be arranged, where appropriate, on sides of the closure parts facing one another. In this context, it has also proven advantageous, if the pressure chamber of the first closure part is also assigned to the second closure part so that there may be stated that there is a common pressure chamber for simultaneously applying a control pressure on both closure parts. By this means, an additional or separate control line is eliminated, particularly as such a control line is already present, by which means the design of the rotary feedthrough is further simplified.

The clutch arrangement according to the invention has a hydraulically-actuated clutch device. The clutch device in turn has a first clutch to which a first pressure chamber is assigned for actuating the first clutch. Thus, the first pressure chamber may, for example, interact with an actuating piston which exerts an actuating force on the first clutch when the pressure is increased in the first pressure chamber. The clutch is preferably a disk clutch. In addition, the clutch arrangement has a rotary feedthrough of the previously described type according to the invention, wherein the second supply line of the rotary feedthrough is fluidly connected to the first pressure chamber. Consequently, a clutch arrangement is created whose first clutch may be locked in the actuating position, which may be a closed position or open position, in that the closure part of the rotary feedthrough may be translated from the open position in to the closed position after a successful pressure build up in the first pressure chamber, in order to reduce the pressure within the first supply line in connection with this. Due to the compact rotary feedthrough and the easily controlled closure part in the rotary feedthrough, a similarly compactly designed and easily controllable clutch arrangement may be created with a lockable first clutch. It should be noted that the clutch device may have two, three, or more clutches, to which a corresponding closure part, supply lines, and, where appropriate, a control line may be assigned for the rotary feedthrough.

In one preferred embodiment of the clutch arrangement according to the invention, the first component is fixed on a housing as a support tube, which preferably stationary or non-rotating, and the second component is designed as a clutch hub, wherein the clutch hub is preferably arranged on the input side, thus on the side of the torque input, of the clutch device.

In one particularly preferred embodiment of the clutch arrangement according to the invention, the clutch device is designed as a double clutch device with a second clutch, to which a second pressure chamber is assigned for actuating the second clutch, wherein the second pressure chamber may be fluidly connected to the fourth supply line of the rotary feedthrough.

As already previously indicated, in another advantageous embodiment of the clutch arrangement according to the invention, a fluid pressure is maintainable in the first and/or second pressure chamber by the closure part and/or second closure part in its closed position, so that a clutch device is provided whose first and/or second clutch is lockable in an actuating position, preferably the closed position, due to the advantageous rotary feedthrough including the closure part and/or second closure part.

The invention will be subsequently described in greater detail with the aid of an exemplary embodiment with reference to the appended drawings. As shown in:

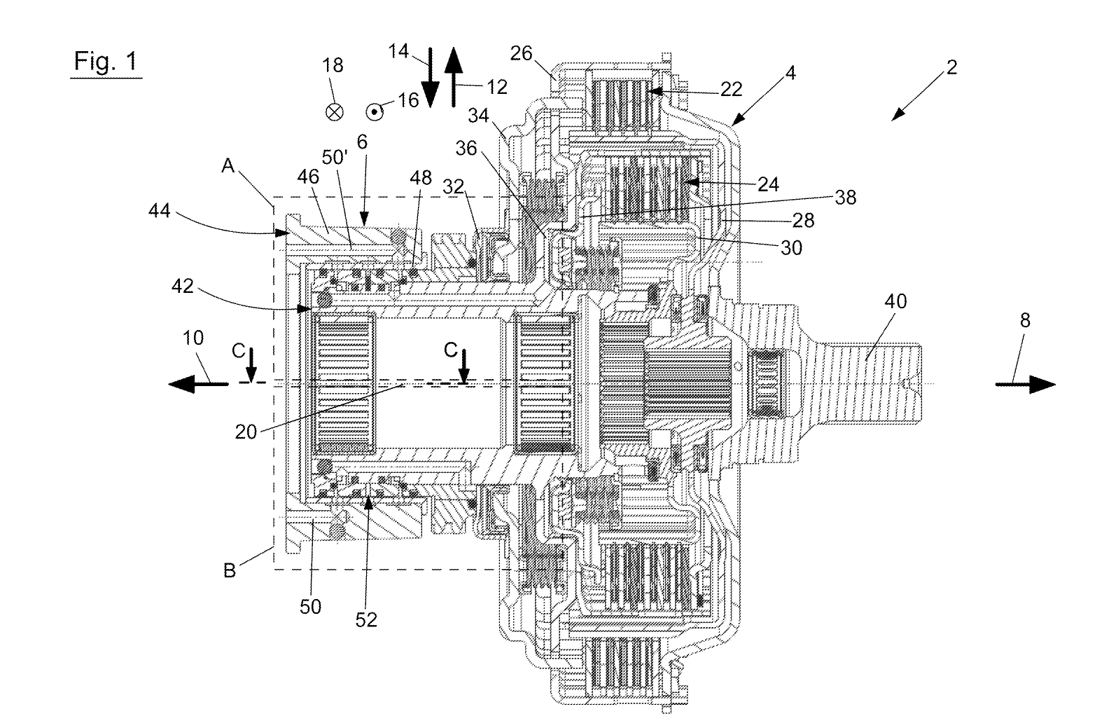

FIG. 1 one embodiment of a clutch arrangement with a rotary feedthrough in a cutaway depiction,

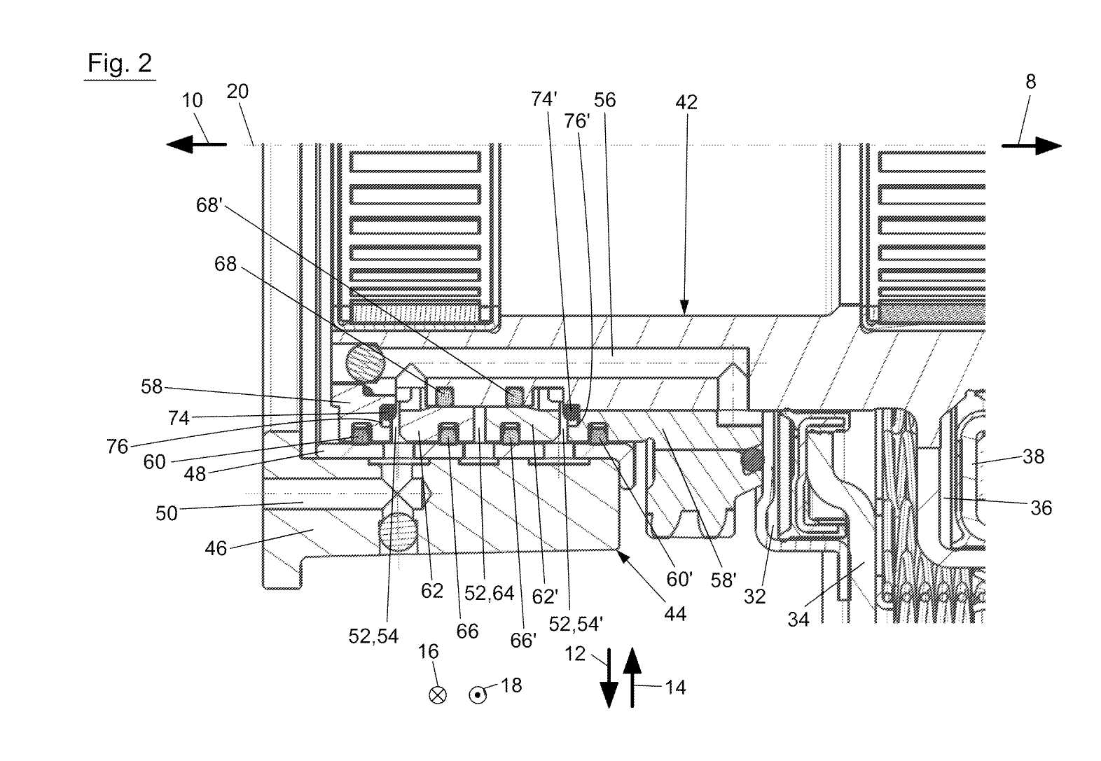

FIG. 2 an enlarged depiction of section A from FIG. 1,

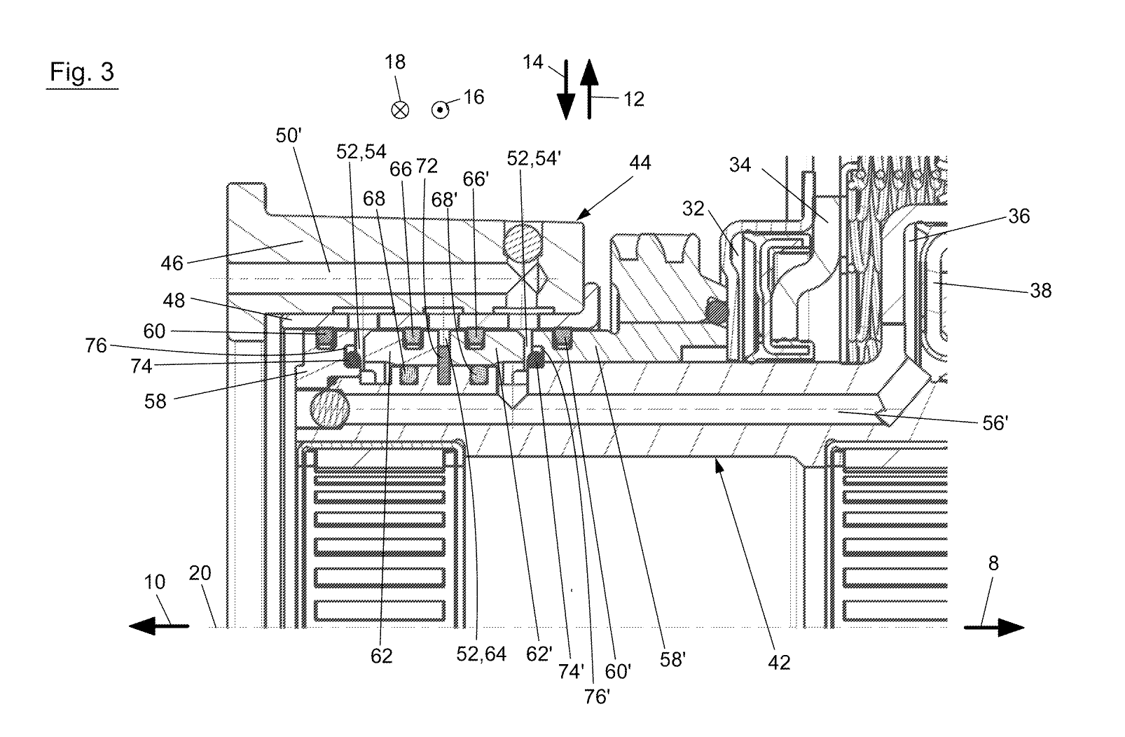

FIG. 3 an enlarged depiction of section B from FIG. 1,

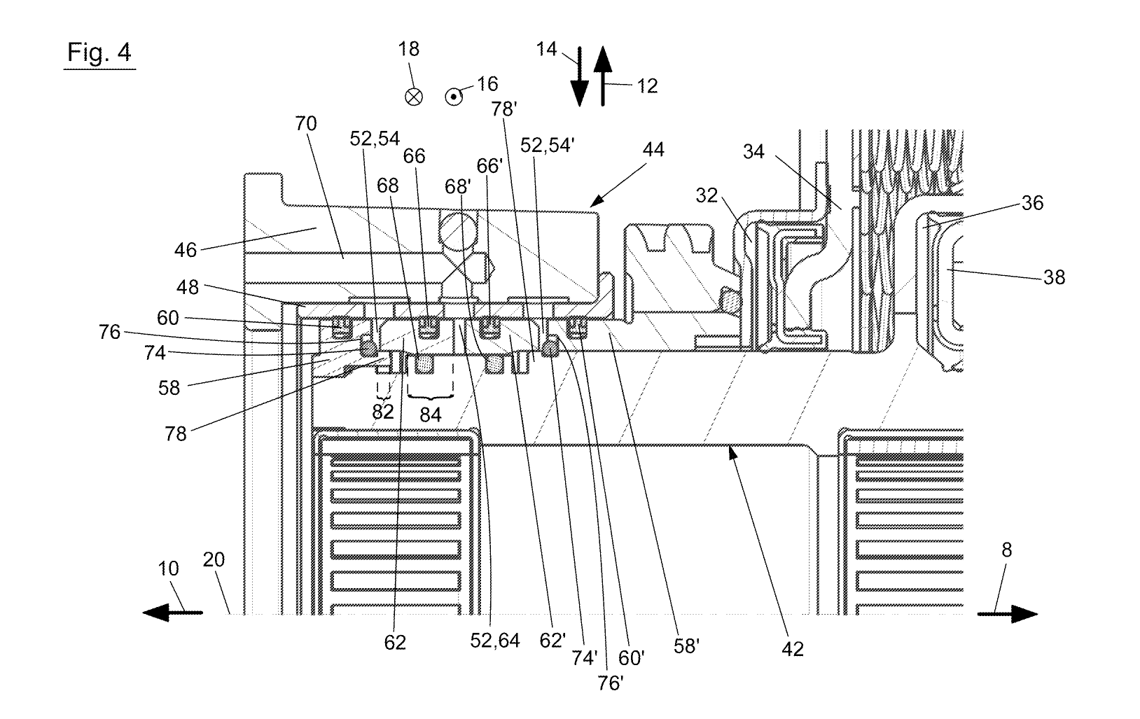

FIG. 4 a partial cross-sectional view along line C-C from FIG. 1,

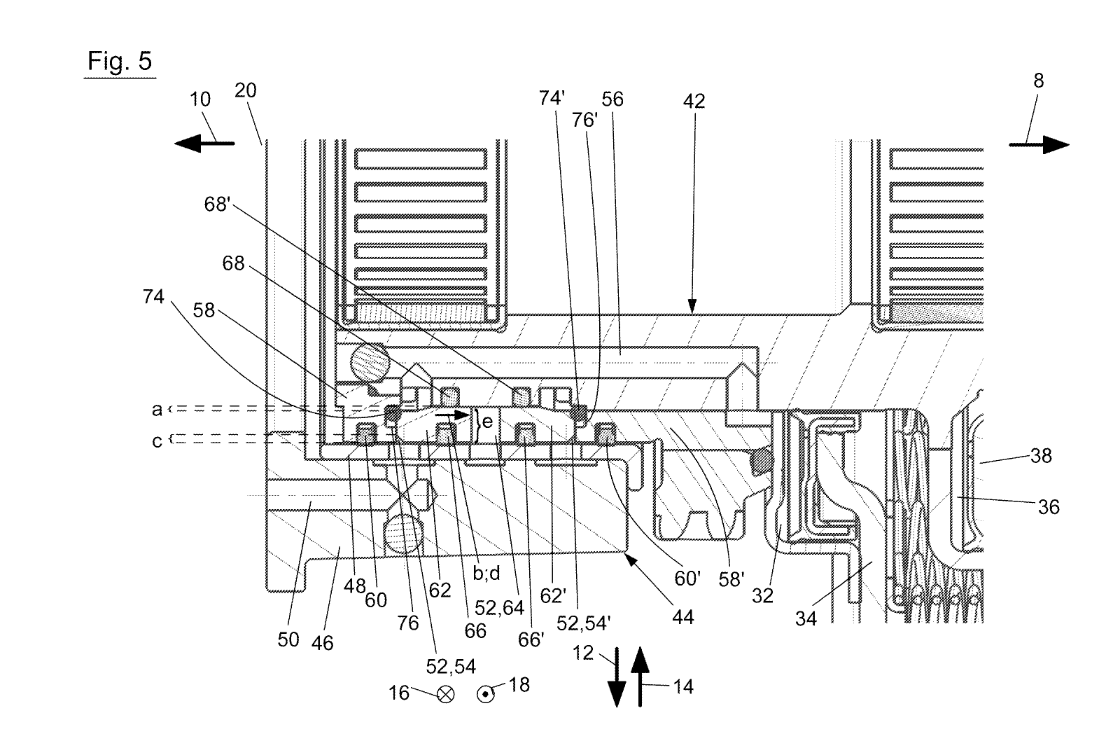

FIG. 5 the depiction from FIG. 2 with the two closure parts in their closed position,

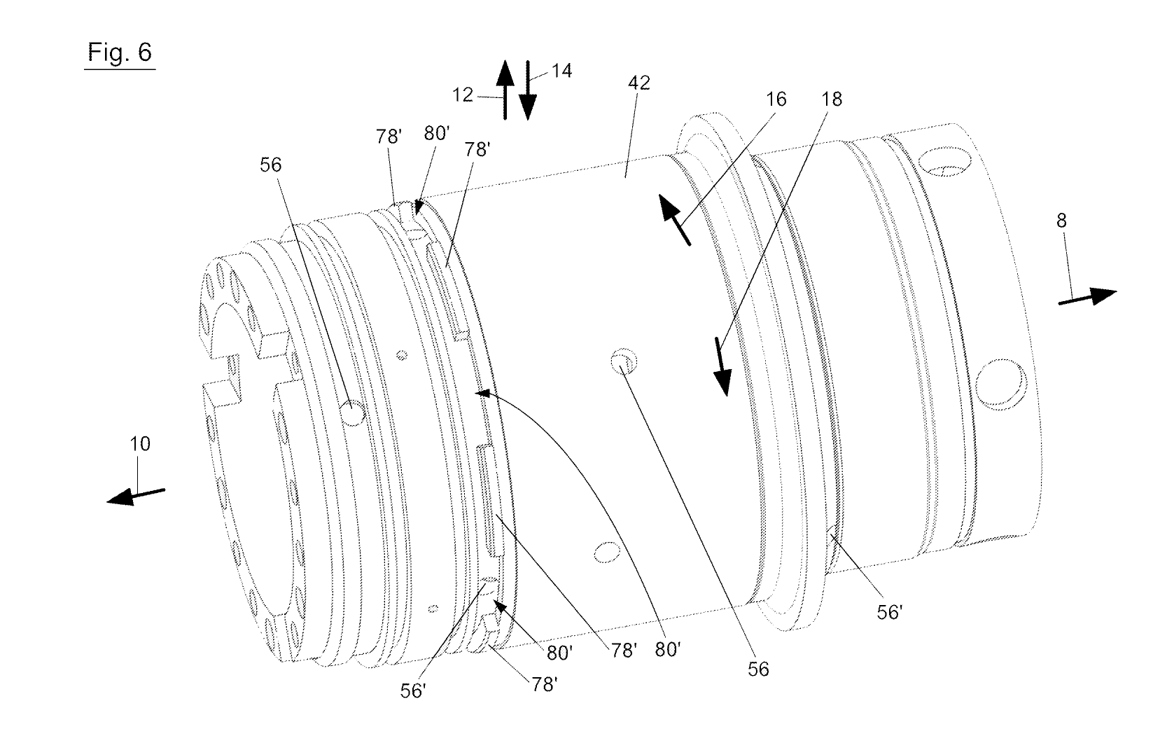

FIG. 6 a perspective depiction of the second component from FIG. 1 by itself without support projections,

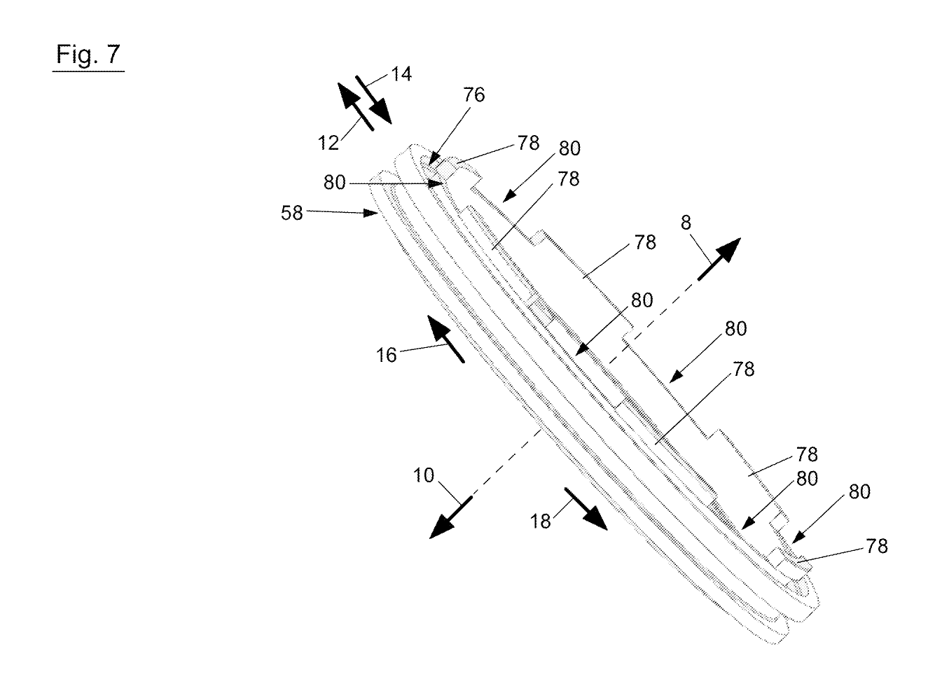

FIG. 7 a perspective depiction of a support projection from FIG. 1 by itself.

FIG. 1 shows a clutch arrangement 2, which is substantially composed from a hydraulically-actuated clutch device 4 and a rotary feedthrough 6. In FIG. 1, opposite axial directions 8, 10, opposite radial directions 12, 14, and opposite circumferential directions 16, 18 are indicated by means of corresponding arrows, wherein clutch device 2 has a central axis of rotation 20 which extends in axial directions 8, 10.

Double clutch device 4 is designed as a concentric double clutch device 4 and has a first clutch lying outward in radial direction 12 and a second clutch 24 lying inward in radial direction 14, which are arranged nested in radial directions 12, 14 and are designed as disk clutches. While first clutch 22 functions for selective rotary driving connection between an input side 26 and a first output side 28, second clutch 24 functions for selective rotary driving connection between input side 26 and a second output side 30. Both clutches 22, 24 are designed as normally open clutches.

To actuate first clutch 22, double clutch device 4 has a first pressure chamber 32, which interacts with a first actuating piston 34 which is assigned to first clutch 22. By applying a corresponding fluid pressure to first pressure chamber 32, first actuating piston 34 is pressible in axial direction 8 against the disk set of first clutch 22 so that first clutch 22 is closed. In addition, double clutch device 4 has a second pressure chamber 36, which interacts with a second actuating piston 38, which is assigned to second clutch 24 so that by applying a corresponding fluid pressure to second pressure chamber 36, second actuating piston 38 may be pressed in axial direction 8 against the disk set of second clutch 24 in order to close the same.

Double clutch device 4 has a first clutch hub 40, which faces in axial direction 8, is in rotary driving connection with input side 26, and is connectable to a drive unit, not depicted in greater detail. In contrast, on the side facing in axial direction 10, double clutch device 4 has a second clutch hub 42, which is connected rotationally fixed to input side 26 and is designed as substantially tubular, wherein second clutch hub 42 forms a second component of rotary feedthrough 6 and is therefore also designated as second component 42 in the following. Second component 42 extends in axial direction 10 into a support tube 44, so that second component 42 is supported or supportable in radial direction 12 on support tube 44, wherein second component is rotatable about axis of rotation 20 in circumferential direction 16, 18 relative to support tube 44, and support tube 44 forms a first component of rotary feedthrough 6, so that support tube 44 is subsequently designated as first component 44 of rotary feedthrough 6.

First component 44 is stationary and thus designed as non-rotatable, wherein first component 44 may be fixed on a housing, for example, a transmission housing, for this purpose. First component 44, designed as substantially tubular, surrounds second component 42 outwardly in radial direction 12 so that first component 44 of rotary feedthrough 6 is designed as a radially outer component and second component 42 of rotary feedthrough 6 is designed as a radially inner component. Second component 42 is thereby composed substantially from an outer tubular body 46 and a sleeve 48, pressed or inserted into tubular body 46, which faces second component 42 inward in radial direction 14 in order to reduce friction between first component 44 and second component 42 when second component 42 is rotated about axis of rotation 20 relative to first component 44.

As is particularly clear from FIG. 2, a first supply line 50 is formed in first component 44 and is connected via its end facing in axial direction 10 to a hydraulic supply line, not depicted in greater detail. First supply line 50 opens at its end facing away from the hydraulic supply line into an annular space 52, extending in circumferential direction 16, 18, which is formed in radial direction 12, 14 between radially nested components 42, 44 of rotary feedthrough 6. Stated more precisely, a section of annular space 52 is designed as so-called connection space 54 into which first supply line 50 opens. In contrast, a second supply line 56 is formed in second component 42, which opens on the one side into connection space 54 and on the other side into first pressure chamber 32 of double clutch device 4. Consequently, first supply line 50 and second supply line are fluidly connected or fluidly connectable via connection space 54 formed in annular space 52.

Connection space 54 is delimited in axial direction 10 by a radial support projection 58, wherein radial support projection 58, as is depicted again alone and in perspective in FIG. 7, is fixed on second component 42 of rotary feedthrough 6 as an attached part in the depicted embodiment. Stated more precisely, support projection 58, designed substantially as annular and initially manufactured separately, is fixed rotationally fixed on second component 42 in axial direction 8, 10. Alternatively, however, support projection 58 might also be designed as one piece with second component 42. A rotary feedthrough seal 60, which is preferably formed by a torlon ring, is arranged in a groove of support projection 58 facing outward in radial direction 12. Further design points of support projection 58 will be subsequently described in greater detail.

In contrast, connection space 54 within annular space 52 is delimited in axial direction 8 by a first closure part 62 arranged in annular space 52, said closure part divides annular space 52 in axial direction 8, 10 into specified connection space 54 and a pressure chamber 64 formed within annular space 52, wherein the later is formed on the side of first closure part 62 facing in axial direction 8.

First closure part 62 is designed as annular. A rotary feedthrough seal 66 acting between first closure part 62 and first component 44 both for sealing connection space 54 and also for sealing pressure chamber 64 on first closure part 62 is arranged in a groove of first closure part 62 facing outward in radial direction 12. Rotary feedthrough seal 66 is designed as a ring seal, preferably again as a torlon ring. In addition a seal 68 is provided, acting between first closure part 62 and second component 42, for sealing both connection space 54 and also pressure chamber 64. Seal 68 designed as an annular seal is thereby arranged on second component 42. For this purpose, seal 68 is arranged in a groove in the side of second component 42 facing outward in radial direction 12 and extending in circumferential direction 16, 18.

Even if—as subsequently described in greater detail—first closure part 62 is displaceable in axial direction 8, 10 relative to second component 42, it is still preferred if first closure part 62 is in rotary driving connection with second component 42, wherein such a rotary driving connection may be generated, for example, via a positive locking between first closure part 62 and second component 42. Alternatively, instead of seal 68, a seal might be used which is fixed on first closure part 62 on the one side and second component 42 on the other side while achieving a rotary driving connection between first closure part 62 and second component 42. A flexible flat seal, for example, might provide this, which namely facilitates an axial displacement of first closure part 62 due to its flexibility; however, also generates a rotary driving connection due to the fixing on first closure part 62 and second component 42, and similarly guarantees a sealing of connection space 54 and pressure chamber 64 in the area between first closure part 62 and second component 42.

As already previously indicated, first closure part 62 may be displaced in axial direction 8, 10 relative to second component 42. In this way, first closure part 62 may be translated from the open position, shown in FIG. 2, in which first supply line 50 and second supply line 56 are fluidly connected via connection space 54, in axial direction 10 into a closed position, which is shown in FIG. 5 and in which first supply line 50 and second supply line 56 are fluidly decoupled. In this way, a fluid pressure, initially generated via first supply line 50, connection space 54, and second supply line 56 in the open position of first closure part 62 may be maintained or preserved in first pressure chamber 32, in that first closure part 62 is subsequently translated into the closed position according to FIG. 5. Subsequently, the pressure within first supply line 50 may be reduced, without reducing the pressure in first pressure chamber 32 of first clutch 22, which is thereby locked in its actuating position, in this case in the closed position.

First closure part 62 is hydraulically driven during the previously mentioned translation or displacement of first closure part 62 from the open position according to FIG. 2 into the closed position according to FIG. 5. For this purpose, a control pressure, which may be changed independently of a fluid pressure within first supply line 50, connection space 54, and second supply line 56, may be applied for this purpose to previously mentioned pressure chamber 64 within annular space 52. For this purpose, a control line 70 is provided in first or second component 44, 42, in this case first component 44, for applying a control pressure to pressure chamber 64, wherein specified control line 70 is shown in FIG. 4. Thus, control line 70 opens inward in radial direction 14 into specified pressure chamber 64. Consequently, pressure chamber 64 is arranged on the side of first closure part 62 facing away from connection space 54 in axial direction 8, wherein first closure part 62 analogously forms an annular hydraulic piston.

In the open position of first closure part 62, said closure part is supported in axial direction 8 on a support part 72, which may be formed, for example, by a securing ring or a support pin. Support part 72 is fixed on second component 42 so that it may be said that there is an indirect support of first closure part 62 on second component 42 in axial direction 8 via support part 72, wherein support part 72 is particularly visible in FIG. 3.

In contrast, in the closed position according to FIG. 5, first closure part 62 is supported in axial direction 10 on second component 42, and again indirectly via previously mentioned support projection 58. Furthermore, a seal 74, acting between first closure part and support projection 58, is thereby provided for sealing first supply line 50 with respect to second supply line 56 in the closed position of first closure part 62, wherein flexible or compressible seal 74 is arranged or fixed on support projection 58. In the closed position shown in FIG. 5, first closure part 62 is not, however, exclusively supported indirectly on support projection 58 via seal 74. Instead, seal 74 is arranged in a circumferential groove 76 (FIGS. 5 and 7) facing in axial direction 10 in such a way that first closure part 62 is supported in its closed position on support projection 58 in axial direction 10 both directly and also during partial compression of seal 74 indirectly via seal 74, as this may be gathered from FIG. 5. In this way, seal 74 is not compressed as strongly, by which means it is unloaded and a high durability is ensured for the same.

In addition, first closure part 62 is supported or supportable inward in radial direction 14 on second component 42 in two support areas separated from one another in axial directions 8, 10, both in its closed position according to FIG. 5 and also in its open position according to FIG. 2. For this purpose support projection 58—as is depicted in FIGS. 4 and 7—has multiple axial projections 78 spaced apart from one another in circumferential direction 16, 18, between which corresponding intermediate spaces 80 lying therebetween are formed. Thus, first closure part 62 is indirectly supported or supportable on second component 42 via support projection 58 inward in radial direction 14 in a first support area 82, regardless of its position relative to second component 42. If first closure part 62 is located in its open position, then first and second supply lines 50, 56 are fluidly connected via intermediate spaces 80 released between projections 78 by first closure part 62. In a second support area 84, first closure part 62 is, in contrast, directly supported or supportable on second component 42 inward in radial direction 14, wherein seal 68 is additionally arranged in second support area 84.

In order to be able to return first closure part 62, displaced into the closed position according to FIG. 5, back into the open position in a relatively easy way, first closure part 62 has a first active surface a, facing in axial direction 10 and extending in circumferential direction 16, 18, which faces connection space 54 in such a way that it is exposed to a fluid pressure in first supply line 50 in the closed position of first closure part 62 and is designed in such a way that the fluid pressure in first supply line 50, consequently also in connection space 54 assigned to first active surface a, results in a force b acting on first closure part 62 in the direction of the open position, wherein force b acts in axial direction 8 in this case. In addition, first closure part 62 has a second active surface c, extending in circumferential direction 16, 18 and facing connection space 54, which is exposed to a fluid pressure in second supply line 56 in the closed position according to FIG. 5 and is designed in such a way that the fluid pressure in second supply line 56, consequently also in the section of connection space 54 assigned to second active surface c, results in a force d acting on first closure part 62 in the direction of the open position, which again acts in axial direction 8. Second active surface c hereby has a fail safe function, i.e., if the control pressure in pressure chamber 64 should drop or fail, then the pressure maintained or preserved in second supply line 56 and first pressure chamber 32 continues to generate the specified force d, so that first closure part 62 is moved back into its open position. In the case of both active surfaces a, c, these are respectively generated via a corresponding chamfer on first closure part 62. Both first active surface a and also second active surface c are also significantly smaller than an active surface e of first closure part 62 facing pressure chamber 64, so that only a low control pressure is required within pressure chamber 64 to maintain first closure part 62 in its closed position.

In addition, rotary feedthrough 6 has an arrangement very similar to the previously described arrangement in order to be able to also apply fluid pressure to second pressure chamber 36 of second clutch 24 and to lock second clutch 24 in the way described. To prevent repetitions, substantially corresponding components are subsequently designated with the same reference numeral, however, with an apostrophe, wherein the previous description correspondingly applies.

Furthermore, a third supply line 50′ (FIG. 3) is provided in first component 44, and a fourth supply line 56′ in second component 42, which supply lines are fluidly connected or fluidly connectable via a second connection space 54′ formed in annular space 52, wherein a second closure part 62′ is arranged in annular space 52 and is translatable from an open position, according to FIG. 2 in which third and fourth supply line 50′, 56′ are fluidly connected via second connection space 54′, into a closed position, according to FIG. 5 in which third and fourth supply line 50′, 56′ are fluidly decoupled. However, first closure part 62 and second closure part 62′ are thereby translatable from the open position into the respective closed position in opposite directions, in this case, in axial directions 8 and 10.

Pressure chamber 64, already assigned to first closure part 62 for driving first closure part 62, is similarly assigned to second closure part 62′, so that by applying pressure to pressure chamber 64 with the control pressure, first closure part 62 and similarly second closure part 62′ are driven from the open position into the closed position. Fourth supply line 56′ is also fluidly connected to second pressure chamber 36 of second clutch 24, as this is gathered, in particular from FIGS. 1 and 3.

Radial support projection 58′, on which second closure part 62′ is supported in axial direction 8 in its closed position according to FIG. 5, is also designed in this case as a component attached to second component 42 and is again connected rotationally fixed to second component 42.

As is clear in FIG. 6, projections 78′ for radial support of second closure part 62′ on second component 42 inward in radial direction 14 are, however, not provided on support projection 58′, but instead directly on second component 42, wherein these projections 78′ are preferably designed as one piece with second component 42.

### REFERENCE SIGN LIST

2 Clutch arrangement
4 Double clutch device
6 Rotary feedthrough
8 Axial direction
10 Axial direction
12 Radial direction
14 Radial direction
16 Circumferential direction
18 Circumferential direction
20 Axis of rotation
22 First clutch
24 Second clutch
26 Input side
28 First output side
30 Second output side
32 First pressure chamber
34 First actuating piston
36 Second pressure chamber
38 Second actuating piston
40 First clutch hub
42 Second clutch hub/second component
44 Support tube/first component
46 Tubular body
48 Sleeve
50 First supply line
50′ Third supply line
52 Annular space
54, 54′ Connection space
56 Second supply line
56′ Fourth supply line
58, 58′ Radial support projection
60, 60′ Rotary feedthrough seal
62 First closure part
62′ Second closure part
64 Pressure chamber
66, 66′ Rotary feedthrough seal
68, 68′ Seal
70 Control line
72 Support part
74, 74′ Seal
76, 76′ Groove
78, 78′ Projections
80, 80′ Intermediate spaces
82 First support area
84 Second support area
a First active surface
b Force
c Second active surface
d Force
e Active surface

1. A rotary feedthrough (6) for a fluid comprising a first component (44) with a first supply line (50) and a second component (42) with a second supply line (56), which are arranged radially nested to form an intermediate annular space (52) and are rotatable relative to one another, wherein the first supply line (50) and the second supply line (56) are fluidly connected or fluidly connectable via a connection space (54) formed in the annular space (52), characterized in that at least one closure part (62) is arranged in the annular space (52) and is translatable from an open position, in which the first and second supply line (50, 56) are fluidly connected via the connection space (54), into a closed position, in which the first and second supply line (50, 56) are fluidly decoupled.

2. The rotary feedthrough (6) according to claim 1, characterized in that the closure part (62) is designed as annular, and/or is displaceable from the open position into the closed position preferably in the axial direction (8, 10), and/or is in rotary driving connection with the second component (42).

3. The rotary feedthrough (6) according to claim 1, characterized in that the closure part (62) is hydraulically drivable, wherein a pressure chamber (64) to which a control pressure can be applied, is formed in the annular space (52) and is preferably assigned to the closure part (62), the control pressure is changeable, where appropriate, independent of a fluid pressure within the first and/or second supply line (50; 56), and a control line (70) is provided particularly preferably in the first or second component (44, 42) for applying the control pressure to the pressure chamber (64), and the pressure chamber (64) is designed, where appropriate, on the side of the closure part (62) facing away from the connection space (54) in axial direction (8, 10).

4. The rotary feedthrough (6) according to claim 3, characterized in that the closure part (62) has a first active surface (a), which is exposed to a fluid pressure in the first supply line (50) in the closed position of the closure part (62) and is designed in such a way that the fluid pressure in the first supply line (50) results in a force (b) acting on the closure part (62) in the direction of the open position, and/or has a second active surface (c), which is exposed to a fluid pressure in the second supply line (56) in the closed position of the closure part (62) and is designed in such a way that the fluid pressure in the second supply line (56) results in a force (d) acting on the closure part (62) in the direction of the open position, wherein the first and/or second active surface (a; c) is preferably smaller than an active surface (e) facing the pressure chamber (64).

5. The rotary feedthrough (6) according to claim 1, characterized in that a seal (66) for sealing the connection space (54) is provided between the closure part (62) and the first component (44) and is preferably arranged on the closure part (62), wherein the seal (66), where appropriate designed as an annular seal or torlon ring, is particularly preferably arranged in a groove in the closure part (62).

6. The rotary feedthrough (6) according to claim 1, characterized in that a seal (68), acting between the closure part (62) and the second component (42), is provided for sealing the connection space (54), wherein the seal (68), where appropriate designed as an annular seal, is preferably arranged on the second component (42), particularly preferably in a groove in the second component (42), and/or is fixed on the closure part (62) and the second component (42) while achieving a rotary driving connection between the closure part (62) and the second component (42), and, where appropriate, is designed as a flexible flat seal.

7. The rotary feedthrough (6) according to claim 1, characterized in that the closure part (62) is supported or supportable in its closed position on the second component (42) in axial direction (8), preferably on a radial support projection (58), which is particularly preferably designed as a component attached on the second component (42), where appropriate rotationally fixed, and/or is designed as an attached part fixed on second component (42) in axial direction (8, 10) or is designed as one piece with the second component (42), and/or a seal (74), acting between the closure part (62) and the second component (42), where appropriate the support projection (58), is provided for sealing the first supply line (50) with respect to the second supply line (56) in the closed position of the closure part (62), said seal is preferably arranged on the second component (42), where appropriate on the support projection (58), wherein the closure part (62) is supported or supportable in its closed position in axial direction (10) particularly preferably both directly on the second component (42) or on the support projection (58) and also indirectly via seal (74) via partial compression of the seal (74).

8. The rotary feedthrough (6) according to claim 7, characterized in that the closure part (62) is supported or supportable both in the closed position and also in the open position on the second component (42) in radial direction (14) on two support areas (82, 84) separated from one another in axial direction (8, 10), wherein the closure part (62) is supported or supportable in radial direction (14) on the second component (42), where appropriate the support projection (58) in one of the two support areas (82; 84), preferably via multiple projections (78) spaced apart from one another with intermediate spaces (80) lying therebetween in such a way that, in the open position of the closure part (62), the first and second supply line (50, 56) are fluidly connected via the intermediate spaces (80), and the projections (78) are particularly preferably spaced apart from one another in circumferential direction (16, 18).

9. The rotary feedthrough (6) according to claim 1, characterized in that one of the components (44; 42), preferably the first component (44), is designed as stationary and/or the second component (42) is designed as the radially inner component.

10. The rotary feedthrough (6) according to claim 1, characterized in that a third supply line (50′) is provided in the first component (44) and a fourth supply line (56′) is provided in the second component (42), which are fluidly connected or fluidly connectable via a second connection space (54′) formed in the annular space (52), wherein a second closure part (62′) is arranged in the annular space (52) and can be translated from an open position, in which the third and fourth supply lines (50′, 56′) are fluidly connected via the second connection space (54′), into a closed position, in which the third and fourth supply lines (50, 56′) are fluidly decoupled, wherein the closure part (62) and the second closure part (62′) are preferably translatable from the open position into the closed position in opposite directions, and the pressure chamber (64) is assigned particularly preferably both to closure part (62) and also to the second closure part (62′).

11. A clutch arrangement (2) comprising a hydraulically-actuated clutch device, which has a first clutch (22), to which a first pressure chamber (32) is assigned for actuating the first clutch (22), and a rotary feedthrough (6) according claim 1, whose second supply line (56) is fluidly connected to the first pressure chamber (32), wherein preferably the first component (44) is designed as a support tube and the second component (42) is designed as a clutch hub, and the clutch device is particularly preferably designed as a double clutch device (4) with a second clutch (24), to which a second pressure chamber (36) is assigned to actuate the second clutch (24) and is fluidly connected to the fourth supply line (56′), wherein a fluid pressure in the first and/or second pressure chamber (32; 36) is maintainable by the closure part (62) and/or the second closure part (62′) in its closed position.
